(19) United States
(12) Patent Application Publication
(10) Pub. No.: US 2026/0238697 A1
(43) Pub. Date: Aug. 13, 2026

(54) RADIO ACCESS NETWORK ASSISTANCE INFORMATION ASSOCIATED WITH EXTENDED REALITY SPLIT PERCEPTION

(71) Applicant: QUALCOMM Incorporated, San Diego, CA (US)

(72) Inventors: Belal Salama Amin KORANY, San Diego, CA (US); Hussein METWALY SAAD, Poway, CA (US); Hyun Yong LEE, San Diego, CA (US); Peerapol TINNAKORNSRISUPHAP, San Diego, CA (US); Simone MERLIN, San Diego, CA (US); Prashanth Haridas HANDE, San Diego, CA (US)

(21) Appl. No.: 19/052,604

(22) Filed: Feb. 13, 2025

(51) Int. Cl. H04L 67/131; G06F 9/50; H04W 28/16

(52) U.S. Cl. CPC H04L 67/131; G06F 9/5072; H04W 28/16; G06F 2209/509

(57) ABSTRACT

Various aspects of the present disclosure generally relate to wireless communication. In some aspects, a user equipment (UE) may transmit radio access network (RAN) assistance information associated with an extended reality (XR) split perception. The UE may receive, based at least in part on the RAN assistance information, an indication associated with a selected split or offload option for the XR split perception. Numerous other aspects are described.

### FIELD OF THE DISCLOSURE

Aspects of the present disclosure generally relate to wireless communication and specifically relate to techniques, apparatuses, and methods associated with radio access network assistance information associated with extended reality split perception.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication includes one or more memories; and one or more processors, coupled to the one or more memories, the one or more processors individually or collectively configured to: transmit radio access network (RAN) assistance information associated with an extended reality (XR) split perception; and receive, based at least in part on the RAN assistance information, an indication associated with a selected split or offload option for the XR split perception.

In some implementations, an apparatus for wireless communication includes one or more memories; and one or more processors, coupled to the one or more memories, the one or more processors individually or collectively configured to: receive RAN assistance information associated with an XR split perception; and transmit, based at least in part on the RAN assistance information, an indication associated with a selected split or offload option for the XR split perception.

In some implementations, a method of wireless communication performed by a user equipment (UE) includes transmitting RAN assistance information associated with an XR split perception; and receiving, based at least in part on the RAN assistance information, an indication associated with a selected split or offload option for the XR split perception.

In some implementations, a method of wireless communication performed by a network node includes receiving RAN assistance information associated with an XR split perception; and transmitting, based at least in part on the RAN assistance information, an indication associated with a selected split or offload option for the XR split perception.

In some implementations, a non-transitory computer-readable medium storing a set of instructions for wireless communication includes one or more instructions that, when executed by one or more processors of a UE, cause the UE to: transmit RAN assistance information associated with an XR split perception; and receive, based at least in part on the RAN assistance information, an indication associated with a selected split or offload option for the XR split perception.

In some implementations, a non-transitory computer-readable medium storing a set of instructions for wireless communication includes one or more instructions that, when executed by one or more processors of a network node, cause the network node to: receive RAN assistance information associated with an XR split perception; and transmit, based at least in part on the RAN assistance information, an indication associated with a selected split or offload option for the XR split perception.

In some implementations, an apparatus for wireless communication includes means for transmitting RAN assistance information associated with an XR split perception; and means for receiving, based at least in part on the RAN assistance information, an indication associated with a selected split or offload option for the XR split perception.

In some implementations, an apparatus for wireless communication includes means for receiving RAN assistance information associated with an XR split perception; and means for transmitting, based at least in part on the RAN assistance information, an indication associated with a selected split or offload option for the XR split perception.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of offloaded tasks at an extended reality (XR) device.

FIGS. 4-6 are diagrams illustrating examples associated with radio access network assistance information associated with XR split perception.

FIG. 7 is a flowchart illustrating an example process performed, for example, by a user equipment (UE).

FIG. 8 is a flowchart illustrating an example process performed, for example, by a network node.

FIGS. 9-10 are diagrams of example apparatuses for wireless communication.

### DETAILED DESCRIPTION

A user equipment (UE), which may include or be associated with an extended reality (XR) device, may run XR perception algorithms. The XR perception algorithms may be run to provide an understanding of an environment and/or a user associated with the XR device. The XR perception algorithms may involve depth map generation, image segmentation, three-dimensional (3D) reconstruction, or object tracking. The XR perception algorithms may be complex and high power consuming. The XR perception algorithms may involve a 3D reconstruction and understanding of a scene, which may be critical for XR applications. The 3D reconstruction and understanding may involve an identification of surfaces and objects. The 3D reconstruction and understanding may be based at least in part on a depth mapping, where each pixel in a depth map may represent a depth of an object seen at that pixel. The depth map may be based at least in part on input images.

The XR device may be associated with form factor limitations, so running numerous XR perception algorithms on the XR device may not be feasible. For example, a battery size and/or a thermal limit associated with the XR device may be a constraint for running the XR perception algorithms on the XR device. Running numerous XR perception algorithms may not be feasible in small form factor devices.

An XR perception computation may be split between the XR device (local device) and a remote device, such as a remote server, which may led to significant power savings, enable small factor glasses, or lead to an improved user experience (e.g., update-to-date and more complex algorithms). The XR device may have a limited computational capability and a high power limitation, so with split perception (or split computation), an XR perception processing may be split between the XR device and the remote device. The XR device may perform less heavy compute tasks (e.g., hand tracking). The remote device may perform heavy compute tasks (e.g., rendering). A remote XR perception processing may enhance a user experience by providing a better rendering quality and by reducing a power consumption at the XR device. However, a remote compute, as compared to a local compute, may require favorable radio conditions and may involve a higher latency due to a propagation delay.

Offloading XR perception may create a tradeoff between saved compute power on an XR device versus an added load to a network node. An optimal decision on whether or not to offload the XR perception may depend on information associated with a link quality between the XR device and the network node, a network load, or a utility (e.g., saved compute power at the XR device or a quality of experience (QoE) associated with the XR device). From an XR device perspective, the XR device may have information regarding the link quality or the utility, but the XR device may not have information regarding the network load. From a network perspective, the network node may have information associated with the link quality or the network node, but the network node may not have information regarding the utility. The optimal decision on whether or not to offload the XR perception may not be performed using information regarding the link quality, the network load, and the utility, but rather may be performed only using a subset of the link quality, the network load, and the utility. As a result, in some cases, the offloading of the XR perception from the XR device to a remote device may not be suitable. For example, the XR perception may be offloaded even when the utility indicates that the saved compute power is minimal. As another example, the XR perception may be offloaded even when the network load is relatively high. In these cases, offloading the XR perception from the XR device to the remote device may degrade an overall system performance.

Various aspects relate generally to XR. Some aspects more specifically relate to radio access network (RAN) assistance information associated with XR split perception. In some examples, a UE, which may include or be associated with an XR device, may share RAN assistance information with a network node, which may allow for an XR perception computation to be optimally split between the UE and a remote device. The UE, which may be offloading an XR perception, may provide information regarding a utility associated with the UE. For example, the utility may include saved compute power at the UE, which may be achieved when using a specific split or offloading option indicated in the RAN assistance information. The network node may determine a suitable split or offload option per UE in order to optimize a network wide utility. The network node may share a decision regarding the suitable split or offload option with the UE. The UE may offload the XR perception computation based at least in part on signaling received from the network node.

Particular aspects of the subject matter described in this disclosure can be implemented to realize one or more of the following potential advantages. In some examples, by allowing the UE to share the RAN assistance information with the network node, the described techniques can be used to intelligently manage the XR split perception for the UE. The network node may utilize the RAN assistance information to manage the XR split perception for the UE. Network-assisted split XR decisions may be enabled at the UE, which may differ from traditional XR perception algorithms that do not take network awareness into account when deciding XR split perception. The RAN assistance information may provide the network node with information that would not otherwise be available to the network node. The RAN assistance information may allow the network node to assist with the XR split perception for the UE, which may improve an overall system performance

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

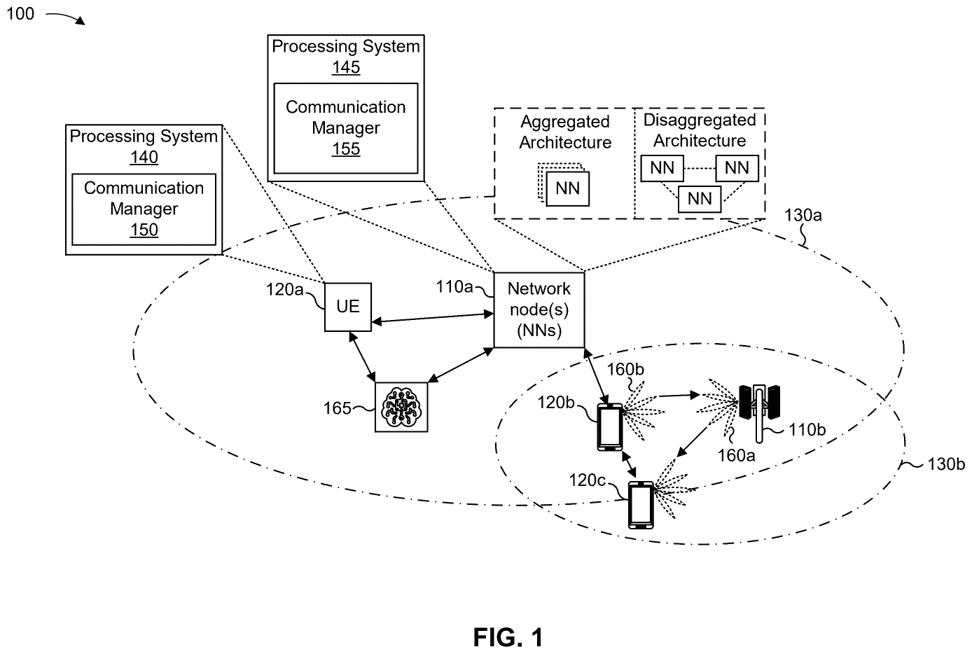

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), QoE, positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., the UE 120) may include a communication manager 150. As described in more detail elsewhere herein, the communication manager 150 may transmit RAN assistance information associated with an XR split perception; and receive, based at least in part on the RAN assistance information, an indication associated with a selected split or offload option for the XR split perception. Additionally, or alternatively, the communication manager 150 may perform one or more other operations described herein.

In some aspects, a network node (e.g., the network node 110) may include a communication manager 155. As described in more detail elsewhere herein, the communication manager 155 may receive RAN assistance information associated with an XR split perception; and transmit, based at least in part on the RAN assistance information, an indication associated with a selected split or offload option for the XR split perception. Additionally, or alternatively, the communication manager 155 may perform one or more other operations described herein.

As indicated above, FIG. 1 is provided as an example. Other examples may differ from what is described with regard to FIG. 1.

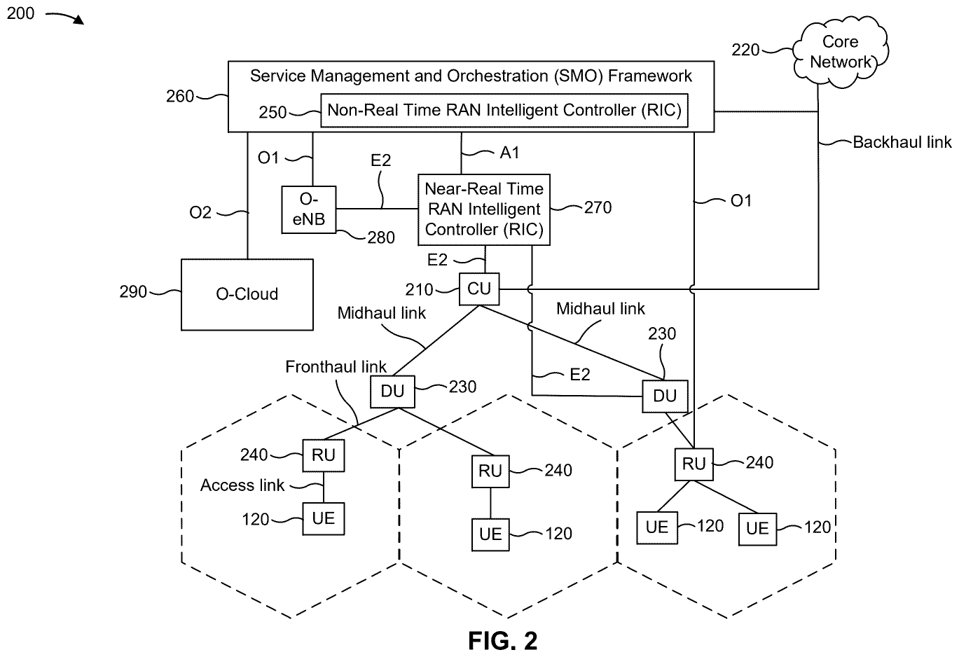

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

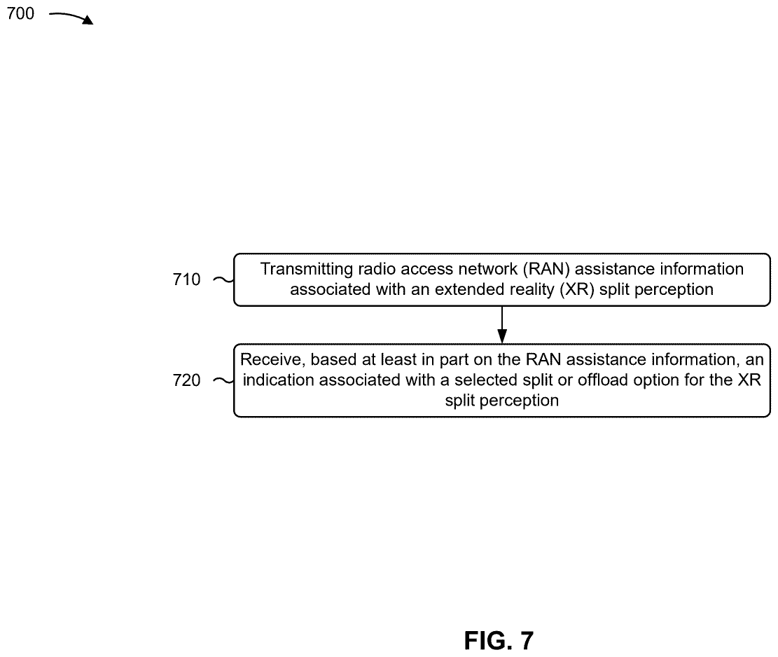

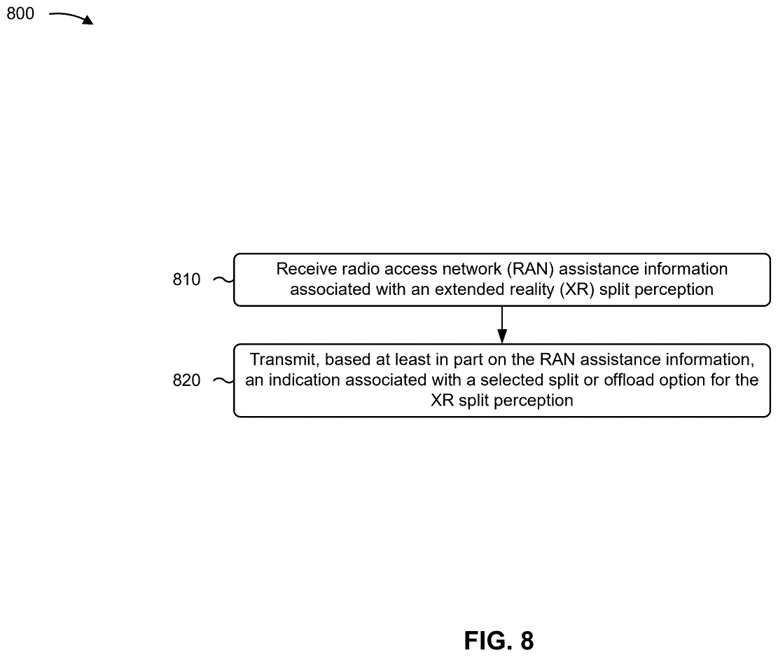

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with RAN assistance information associated with XR split perception, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

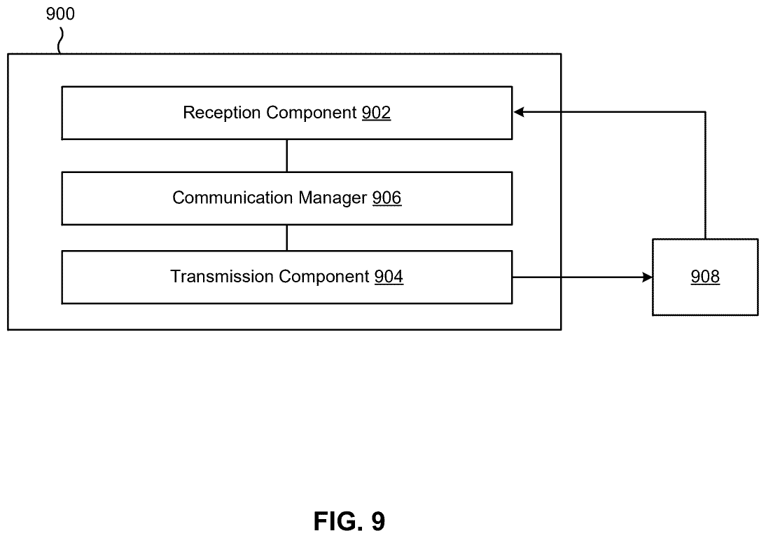

In some aspects, a UE (e.g., the UE 120) includes means for transmitting RAN assistance information associated with an XR split perception; and/or means for receiving, based at least in part on the RAN assistance information, an indication associated with a selected split or offload option for the XR split perception. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

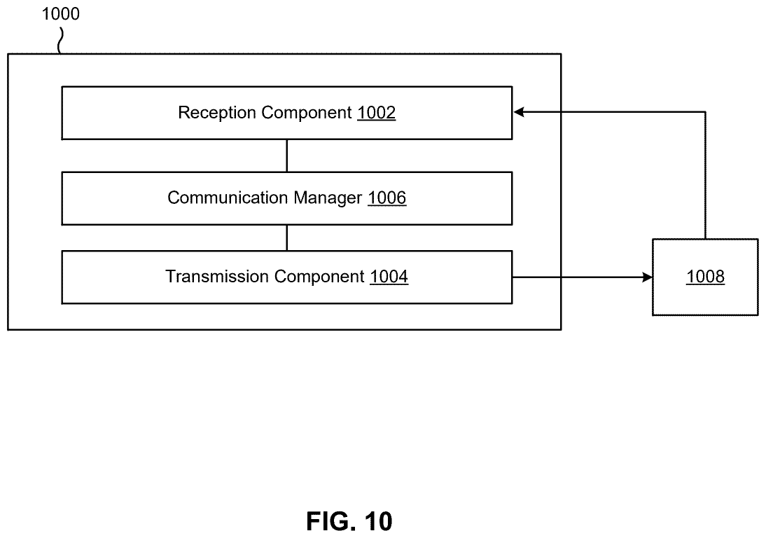

In some aspects, the network node includes means for receiving RAN assistance information associated with an XR split perception; and/or means for transmitting, based at least in part on the RAN assistance information, an indication associated with a selected split or offload option for the XR split perception. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

As indicated above, FIG. 2 is provided as an example. Other examples may differ from what is described with regard to FIG. 2.

A wireless network may be configured to support XR traffic. XR traffic may be associated with immersive technologies such as virtual reality (VR), augmented reality (AR), mixed reality (MR), and levels of virtuality interpolated among VR, AR, and MR. For example, VR is a rendered version of an audiovisual scene, where the rendering is designed to mimic the visual and audio sensory stimuli of the real world as naturally as possible to an observer or a user as they move within the limits defined by the VR application. VR typically requires a user to wear a head mounted display (HMD) to completely replace a field of view with a simulated visual component, and to use headphones, a speaker, and/or another suitable audio device to hear the accompanying audio. Head and motion tracking of the user is usually also needed in VR applications to allow the simulated visual and audio components to be updated in order to ensure that, from the perspective of the user, items and sound sources remain consistent with movements of the user. In AR applications, a user is generally provided with additional information or artificially generated items or content that are overlaid upon a current environment. The additional information or content is usually visual and/or audible and observation of the current environment may be direct, with no intermediate sensing, processing and rendering, or indirect, where perception of the environment may be relayed via sensors and enhanced or processed. MR is an advanced form of AR where some virtual elements are inserted into a physical scene to provide an illusion that the elements are part of the real scene.

XR is expected to improve productivity and convenience for consumers, enterprises, and public institutions in various application areas such as entertainment, training, education, remote support, remote control, communications, or virtual meetings, among other examples. XR can be used in many industry segments, including health care, real estate, shopping, transportation, manufacturing, and/or other industry segments. VR is already used for gaming both at home and at dedicated venues, for virtual tours in the context of real estate, for education and training purposes, and for remote participation at live events such as concerts and sports. Furthermore, AR and MR use cases have significant potential. For example, whereas VR applications rely on HMDs that separate users from physical surroundings and restrict mobility, AR and MR applications allow users to be present in reality and move freely even when using HMDs. Many smartphone users have already experienced basic forms of AR, through games that involve searching for virtual objects in real-world environments and apps that enable shoppers to visualize new furniture in their homes before making a purchase. Furthermore, AR technology may be used with an HMD to free a user's hands, and thereby increase worker efficiency by providing an ability to overlay information on the real world while simultaneously having hands available.

A UE may support one or more XR functionalities. For example, the UE may be an XR device or may be associated with an XR device. For example, the UE may be connected to the XR device via a wired connection or via a wireless connection. The wired connection may be a universal serial bus (USB) connection or a serial advanced technology attachment (SATA) connection. The wireless connection may be a Bluetooth connection, a Wi-Fi connection, or a 5G connection. XR functionalities may include AR, VR, or MR, among other examples. For example, when providing an XR service, the UE may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, or another type of application for which communication flows of streaming data are provided between the UE and the application server, between the XR device and the application server, or between the application server and another device in the wireless network. The application server may be included in an edge server, a cloud environment, or another type of server environment. The UE or the XR device may execute an application client associated with the application hosted by the application server, such as a gaming application client, a video streaming application client, an XR application client, a VR application client, an AR application client, or another type of application client.

The XR device may run XR perception algorithms to enable a favorable user experience. The XR perception algorithms may be run to provide an understanding of an environment and/or a user associated with the XR device. The XR perception algorithms may involve depth map generation, image segmentation, 3D reconstruction, or object tracking. The XR perception algorithms may involve positional tracking, image recognition and tracking, plane detection, hand tracking, local anchors and persistence, spatial mapping and meshing, hit testing, controller tracking, or occlusion. The XR perception algorithms may be complex and high power consuming. The XR perception algorithms may involve a 3D reconstruction and understanding of a scene, which may be critical for XR applications. The 3D reconstruction and understanding may involve an identification of surfaces and objects. The 3D reconstruction and understanding may be based at least in part on a depth mapping, where each pixel in a depth map may represent a depth of an object seen at that pixel. The depth map may be based at least in part on input images. The 3D reconstruction and understanding may be associated with various use cases, such as virtual object identification on a planar surface, occlusion rendering, remote collaboration, collision warning, geofencing, specific surface segmentation, or remote presence.

The XR device may be associated with form factor limitations, so running numerous XR perception algorithms on the XR device may not be feasible. For example, a battery size and/or a thermal limit associated with the XR device may be a constraint for running the XR perception algorithms on the XR device. Running numerous XR perception algorithms may not be feasible in small form factor devices. Different types of XR devices may have different power/thermal requirements. For example, smart glasses may have tighter power/thermal requirements as compared to VR/MR devices and AR devices (e.g., 1-2 watts versus 10 watts).

An XR perception computation may be split between the XR device (local device) and a remote device, such as a remote server, which may led to significant power savings, enable small factor glasses, or lead to an improved user experience (e.g., update-to-date and more complex algorithms). The XR device may have a limited computational capability and a high power limitation, so with split perception (or split computation), an XR perception processing may be split between the XR device and the remote device. The XR device may perform less heavy compute tasks (e.g., hand tracking). The remote device may perform heavy compute tasks (e.g., rendering). A remote XR perception processing may enhance a user experience by providing a better rendering quality and by reducing a power consumption at the XR device. However, a remote compute, as compared to a local compute, may require favorable radio conditions and may involve a higher latency due to a propagation delay.

Splitting the XR perception computation between the XR device and the remote device may not necessarily result in such benefits depending on various factors. One factor is a link condition (e.g., 5G network load or RSRP). A favorable link condition may allow for a larger number of tasks to be offloaded to the remote device. An unfavorable link condition may limit a number of tasks that are able to be offloaded to the remote device. Offloaded tasks may save compute power at the XR device, but may increase a network load and a modem power consumption.

Certain XR perception algorithms may be offloaded when splitting the XR perception computation between the XR device and the remote device. For example, the XR device may offload depth maps, image segmentation, or 3D reconstruction to the remote device, where different amounts of power may be saved at the XR device depending on certain XR perception algorithms that are offloaded. For example, when only the depth maps are offloaded, the XR device may save approximately 610 milliwatts (mW) with a data rate requirement of 12.5 megabits per second (Mbps) and 10 Mbps on an uplink and a downlink, respectively. When both the depth maps and the 3D reconstruction are offloaded, the XR device may save approximately 1 W with a data rate requirement of 12.5 Mbps and 80 Mbps on an uplink and a downlink, respectively.

Certain blocks of a given XR perception algorithm may be offloaded, such as a pre-processing block or a neural network block. For example, the XR device may offload a depth maps pipeline, which may allow the XR device to save approximately 610 mw with a data rate requirement of 12.5 Mbps and 10 Mbps on an uplink and a downlink, respectively. The XR device may offload only a neural network of the depth maps pipeline, which may allow the XR device to save approximately 250 mW with a data rate requirement of 5 Mbps and 10 Mbps on an uplink and a downlink, respectively.

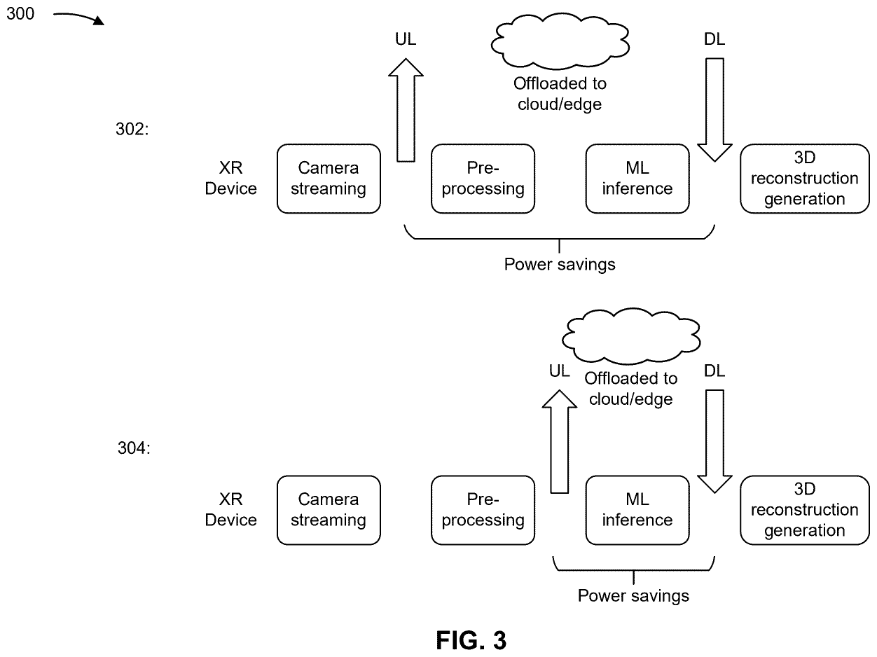

FIG. 3 is a diagram illustrating an example 300 of offloaded tasks at an XR device.

As shown by reference number 302, an XR device may perform a camera streaming. The XR device may offload a pre-processing and an ML inference to a cloud/edge device via an uplink direction. The uplink direction may be associated with an uplink data rate requirement (e.g., 12.5 Mbps). The XR device may receive, via a downlink direction, information from the cloud/edge device based at least in part on the pre-processing and the ML inference. The downlink direction may be associated with a downlink data rate requirement (e.g., 10 Mbps). The XR device may perform a 3D reconstruction generation based at least in part on the information received from the cloud/edge device. By offloading the pre-processing and the ML inference to the cloud/edge device, the XR device may achieve power savings (e.g., approximately 610 mW).

As shown by reference number 304, an XR device may perform a camera streaming. The XR device may perform a pre-processing, which may be based at least in part on the camera streaming. The XR device may offload an ML inference to a cloud/edge device via an uplink direction. The uplink direction may be associated with an uplink data rate requirement (e.g., 5 Mbps). The XR device may receive, via a downlink direction, information from the cloud/edge device based at least in part on the ML inference. The downlink direction may be associated with a downlink data rate requirement (e.g., 10 Mbps). The XR device may perform a 3D reconstruction generation based at least in part on the information received from the cloud/edge device. By offloading the ML inference to the cloud/edge device, the XR device may achieve power savings (e.g., approximately 250 mW).

As indicated above, FIG. 3 is provided as an example. Other examples may differ from what is described with regard to FIG. 3.

Offloading XR perception may create a tradeoff between a saved compute power on an XR device versus an added load to a network node. An optimal decision on whether or not to offload the XR perception may depend on information associated with a link quality between the XR device and the network node, a network load, or a user utility (e.g., saved compute power at the XR device and/or a QoE associated with the XR device). From an XR device perspective, the XR device may have information regarding the link quality and/or the user utility, but the XR device may not have information regarding the network load. From a network perspective, the network node may have information associated with the link quality or the network node, but the network node may not have information regarding the user utility. The optimal decision on whether or not to offload the XR perception may not be performed using information regarding the link quality, the network load, and the user utility, but rather may be performed only using a subset of the link quality, the network load, and the user utility. As a result, in some cases, the offloading of the XR perception from the XR device to a remote device may not be suitable. For example, the XR perception may be offloaded even when the user utility indicates that the saved compute power is minimal. As another example, the XR perception may be offloaded even when the network load is relatively high. In these cases, offloading the XR perception from the XR device to the remote device may degrade an overall system performance.

In various aspects of techniques and apparatuses described herein, a UE, which may include or be associated with an XR device, may share utility and assistance information with a network node, which may allow for an XR perception computation to be optimally split between the UE and a remote device. The UE may provide, to the network node, network assistance for an XR split perception. The UE, which may be offloading an XR perception, may provide information regarding a user utility to the network node. The network node may determine a suitable offload option per UE (or per user) in order to optimize a network wide utility. The network node may share a decision regarding the suitable offload option with the UE. The UE may offload the XR perception computation based at least in part on signaling received from the network node. In some aspects, by allowing the UE to share the utility and assistance information with the network node, the network node may intelligently manage the XR split perception for the UE, which may improve an overall system performance.

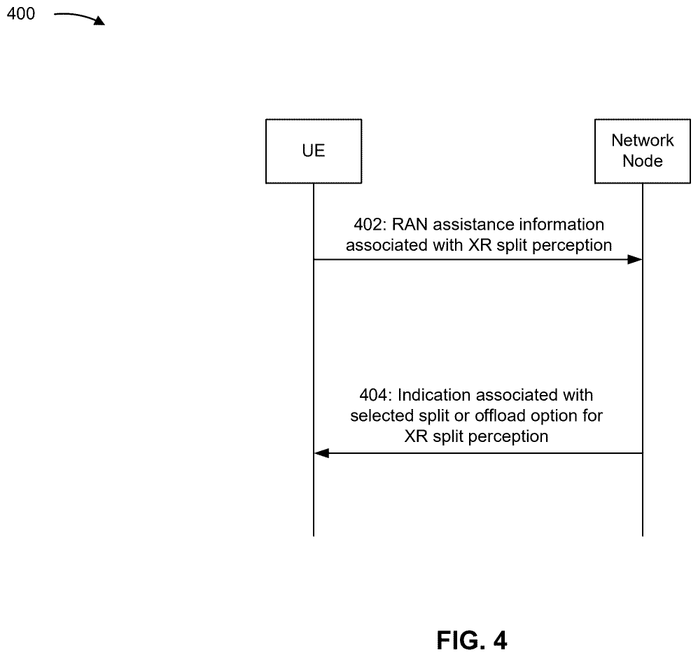

FIG. 4 is a diagram illustrating an example 400 associated with RAN assistance information associated with XR split perception, in accordance with the present disclosure. As shown in FIG. 4, example 400 includes communication between a UE (e.g., UE 120) and a network node (e.g., network node 110). In some aspects, the UE and the network node may be included in a wireless network, such as wireless communication network 100. The UE may include an XR device or the UE may be associated with the XR device. The network node may be associated with a RAN.

As shown by reference number 402, the UE may transmit, to the network node, RAN assistance information associated with an XR split perception. The RAN assistance information may indicate a plurality of possible split or offload options for the XR split perception. Each possible split or offload option may be associated with at least one of a description, an uplink data rate requirement, a packet delay budget (PDB) requirement, a packet error rate (PER) requirement, or a utility. The utility may be a saved compute power at the UE. The utility may be associated with a QoE. The RAN assistance information may indicate modem related information associated with the UE. The modem related information may include a UE modem power consumption profile. The UE modem power consumption profile may indicate a UE power consumption associated with each of the plurality of possible split or offload options.

In some aspects, the UE may transmit the RAN assistance information via an enhanced requested/recommended bitrate (RBR) MAC-CE. The enhanced RBR MAC-CE may indicate at least one of a logical channel identifier (LCID), a quality of service (QoS) flow, a type of utility, a time window during which a provided bitrate query is valid, a number of candidate split or offload options, or a list of supportable bit rates and corresponding utility information. In some aspects, the UE may transmit the RAN assistance information via a RAN visible QoE. The RAN visible QoE may be an application measurement report shared by an application client on the UE with the RAN. In some aspects, the UE may transmit the RAN assistance information via a UE assistance information (UAI) RRC message. The UAI RRC message may indicate other assistance information including modem information associated with the UE. In some aspects, the UE may transmit the RAN assistance information based at least in part on a periodic update or an event trigger.

In some aspects, the UE may share the RAN assistance information with the network node. The RAN assistance information may include utility and assistance information. The UE may provide the RAN assistance information to the network node for an XR split perception. The XR split perception may involve a split processing of XR perception between the UE and the network node. The UE may calculate an overall utility and requirements for one or more split/offload options. The overall utility may indicate an offload gain at the UE, such as an amount of saved compute power. The requirements may be associated with a data rate, a PDB, and/or a PER. The UE may share the overall utility and requirements for the one or more split/offload options with the network node. The UE may not necessarily share a description or purpose associated with each split/offload option. The UE may also transmit, to the network node, other assistance information to assist the network node in deciding an optimal split/offload option. For example, the other assistance information may include modem related information, which may allow the network node to calculate a communication power associated with each possible split/offload option.

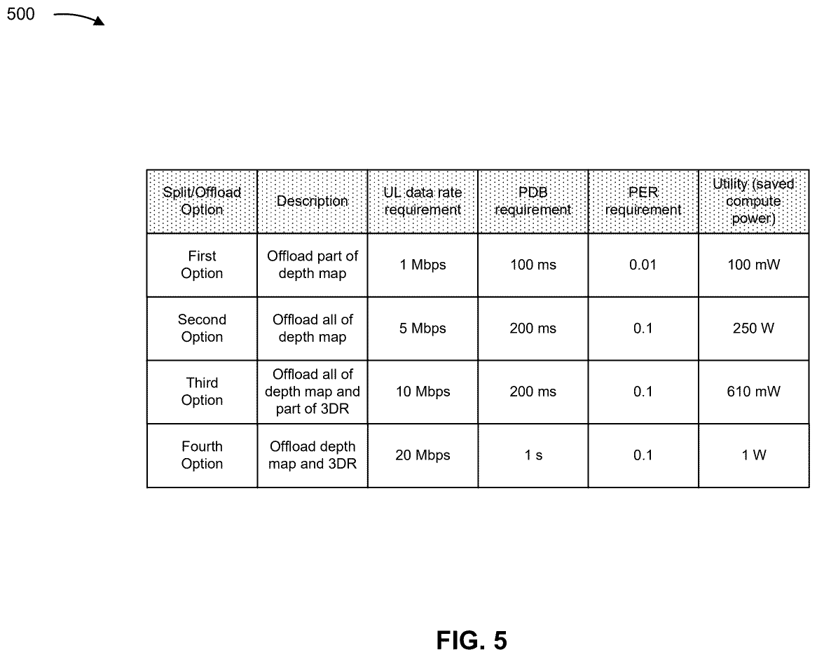

As an example, the UE may identify a table of split/offload options (e.g., as shown in FIG. 5). The table of split/offload options may include a first split/offload option, a second split/offload option, a third split/offload option, and a fourth split/offload option. The first split/offload option may involve offloading a part of a depth map. The first split/offload option may be associated with an uplink data rate requirement of 1 Mbps. The first split/offload option may be associated with a PDB requirement of 100 milliseconds (ms). The first split/offload option may be associated with a PER requirement of 0.01. The first split/offload option may be associated with a utility (saved compute power) of 100 mW. The second split/offload option may involve offloading all of a depth map. The second split/offload option may be associated with an uplink data rate requirement of 5 Mbps. The second split/offload option may be associated with a PDB requirement of 200 ms. The first split/offload option may be associated with a PER requirement of 0.01. The first split/offload option may be associated with a utility (saved compute power) of 250 W. The third split/offload option may involve offloading all of a depth map and a part of a 3D reconstruction. The third split/offload option may be associated with an uplink data rate requirement of 10 Mbps. The third split/offload option may be associated with a PDB requirement of 200 ms. The third split/offload option may be associated with a PER requirement of 0.01. The third split/offload option may be associated with a utility (saved compute power) of 610 mW. The fourth split/offload option may involve offloading a depth map and a 3D reconstruction. The fourth split/offload option may be associated with an uplink data rate requirement of 20 Mbps. The fourth split/offload option may be associated with a PDB requirement of 1 s. The fourth split/offload option may be associated with a PER requirement of 0.01. The fourth split/offload option may be associated with a utility (saved compute power) of 1 W. In this example, different split/offload options of the UE and a tradeoff between utility and requirements may be defined. The UE may indicate the table of split/offload options to the network node as part of the RAN assistance information.

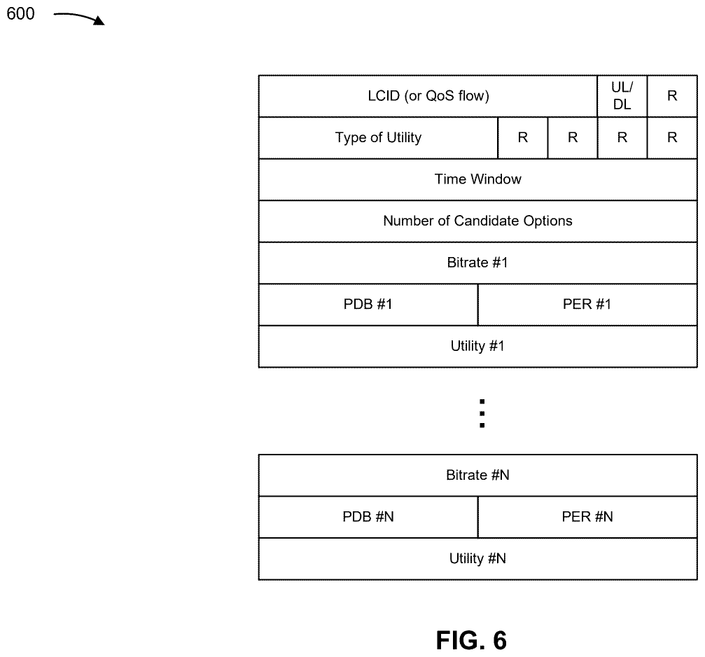

In some aspects, the UE may share the RAN assistance information (e.g., the table of split/offload options) with the network node in accordance with various signaling options. In some aspects, the UE may share the RAN assistance information using an enhanced RBR MAC-CE (e.g., as shown in FIG. 6). The UE may transmit the RBR MAC-CE to signal a rate and utility mapping to the network node. The UE may indicate, via the RBR MAC-CE, a type of utility according to an application associated with the UE (e.g., saved power or QoE). The UE may indicate, via the RBR MAC-CE, a time window during which a provided bitrate query is valid. The UE may indicate, via the RBR MAC-CE, a number of listed options (e.g., a number of candidate options) for the network node to identify a size of the RBR MAC-CE. The UE may indicate, via the RBR MAC-CE, a list of supportable bitrates and relevant utilities (e.g., in a preferred order). In some aspects, the UE may share the RAN assistance information using a RAN visible QoE. The RAN visible QoE may be an application measurement report that is shared by an application client on the UE with a RAN. In some aspects, the UE may share the RAN assistance information using a UAI RRC message. The UE may share other assistance information (e.g., modem information) via the UAI RRC message. In some aspects, the network node may configure the UE with a periodicity for sending the RAN assistance information. For example, the network node may configure the UE with a periodicity for a bitrate/utility map update. The network node may configure the UE to periodically transmit the RAN assistance information. Alternatively, or additionally, the network node may configure the UE to transmit the RAN assistance information when triggered by a change (e.g., an XR perception task is no longer needed).

As shown by reference number 404, the UE may receive, from the network node and based at least in part on the RAN assistance information, an indication associated with a selected split or offload option for the XR split perception. The UE may receive the indication via an RBR MAC-CE. The indication may indicate a selected or recommended bitrate, where the selected split or offload option may be inferred based at least in part on the selected split or offload option. The selected split or offload option may define one or more XR perception related tasks to be performed at the UE and one or more XR perception related tasks to be offloaded to a remote server. The one or more XR perception related tasks may include a depth mapping, a 3D reconstruction, or another type of XR perception task. In some aspects, the selected split or offload option may be based at least in part on a current channel condition of the UE and a current network load. The selected split or offload option may be to maximize a number of UEs having a utility that satisfies a threshold and/or to maximize a minimum utility across a plurality of UEs. The selected split or offload option may be based at least in part on a UE subscription policy. The selected split or offload option may be per UE.

In some aspects, the network node may optimize a network-wide utility function. The network node may use the RAN assistance information received from the UE, as well as RAN assistance information received from other UEs in the cell, to run an optimization algorithm to maximize a network utility given the network node's capacity constraint. The network node may consider current channel conditions of UEs in the cell, as well as a network load (which may be information that is available at the network node), when running the optimization algorithm to maximize the network utility. The network node may run the optimization algorithm to maximize a number of UEs whose utility (e.g., net saved power) is above a certain threshold. The network node may run the optimization algorithm to maximize a minimum utility across all UEs in the cell. The network node may consider UE subscription policies when running the optimization algorithm to maximize the network utility. For example, some UEs may subscribe for a better service than other UEs, which may be part of the UE subscription policies that are considered by the network node. In some aspects, an output of the optimization algorithm may be a selected split/offload option for each UE in the cell. The network node may use an RBR MAC-CE to notify the UE of the selected or recommended bitrate. The UE may infer a selected split/offload option from the selected or recommended bitrate. The UE may employ the selected split/offload option for the XR split perception, which may define which specific XR perception related tasks are to be offloaded to a remote server and which specific XR perception related tasks are to remain on the UE.

In some aspects, network-assisted split XR decisions may be enabled at the UE, which may differ from traditional XR perception algorithms that do not take network awareness into account when deciding XR split perception. The cell may include multiple UEs that are running different XR perception tasks and different XR perception offloading algorithms, and an offloading algorithm behavior for each UE may change depending on the network load.

In some aspects, the UE may transmit the RAN assistance information via an application server. One or more alternative QoS profiles may be used as a container to share the RAN assistance information with the RAN. Each alternative QoS profile may represent one split or offload option. The indication associated with the selected split or offload option may be based at least in part on a selected alternative QoS profile from the one or more alternative QoS profiles.

In some aspects, the UE may share the RAN assistance information with the RAN (e.g., the network node) via an application server. The UE may share the RAN assistance information (e.g., utility table) with the application server using application layer signaling. The application server may utilize an alternative QoS profile as a container to share the RAN assistance information with the RAN. For example, the application server may utilize the alternative QoS profile to share the alternative QoS profile with the RAN via a policy control function (PCF) and a session management function (SMF). Each alternative QoS profile may represent one of the split/offload options. The application server may utilize a new information element (IE) of utility for each of the alternative QoS profiles. The utility may be shared between the SMF and the RAN, such that the SMF may provide the alternative QoS profiles with its related utilities to the RAN. The RAN may select one of the alternative QoS profiles based at least in part on a utility impact on UEs in a cell. The RAN may indicate a selected alternative QoS profile to a network infrastructure, such as a 5G core (5GC) or a 6G core (6GC), as well as to the application server. The application server may share the selected alternative QoS profile (e.g., a selected split/offload option) with the UE.

As indicated above, FIG. 4 is provided as an example. Other examples may differ from what is described with regard to FIG. 4.

FIG. 5 is a diagram illustrating an example 500 associated with RAN assistance information associated with XR split perception, in accordance with the present disclosure.

As shown in FIG. 5, a UE may identify a table of split/offload options. The table of split/offload options may include a first split/offload option, a second split/offload option, a third split/offload option, and a fourth split/offload option. The first split/offload option may involve offloading a part of a depth map. The first split/offload option may be associated with an uplink data rate requirement of 1 Mbps. The first split/offload option may be associated with a PDB requirement of 100 ms. The first split/offload option may be associated with a PER requirement of 0.01. The first split/offload option may be associated with a utility (saved compute power) of 100 mW. The second split/offload option may involve offloading all of a depth map. The second split/offload option may be associated with an uplink data rate requirement of 5 Mbps. The second split/offload option may be associated with a PDB requirement of 200 ms. The first split/offload option may be associated with a PER requirement of 0.01. The first split/offload option may be associated with a utility (saved compute power) of 250 W. The third split/offload option may involve offloading all of a depth map and a part of a 3D reconstruction (3DR). The third split/offload option may be associated with an uplink data rate requirement of 10 Mbps. The third split/offload option may be associated with a PDB requirement of 200 ms. The third split/offload option may be associated with a PER requirement of 0.01. The third split/offload option may be associated with a utility (saved compute power) of 610 mW. The fourth split/offload option may involve offloading a depth map and a 3D reconstruction. The fourth split/offload option may be associated with an uplink data rate requirement of 20 Mbps. The fourth split/offload option may be associated with a PDB requirement of 1 s. The fourth split/offload option may be associated with a PER requirement of 0.01. The fourth split/offload option may be associated with a utility (saved compute power) of 1 W.

As indicated above, FIG. 5 is provided as an example. Other examples may differ from what is described with regard to FIG. 5.

FIG. 6 is a diagram illustrating an example 600 associated with RAN assistance information associated with XR split perception, in accordance with the present disclosure.

As shown in FIG. 6, an enhanced RBR MAC-CE, which may be transmitted from a UE to a network node, may indicate an LCID or a QoS flow. The enhanced RBR MAC-CE may indicate an uplink or a downlink. The enhanced RBR MAC-CE may include one or more reserved bits. The enhanced RBR MAC-CE may indicate a type of utility. The type of utility may be according to the UE's application. For example, the type of utility may be saved power or a QoE. The enhanced RBR MAC-CE may indicate a time window during which a provided bit rate query is valid. The enhanced RBR MAC-CE may indicate a number of candidate options, which may include a number of listed options, which may allow the network node to calculate a size of the enhanced RBR MAC-CE. The enhanced RBR MAC-CE may include a list of supportable bitrates and its relevant utilities (e.g., in a preferred order). For example, the enhanced RBR MAC-CE may indicate a first bitrate, a first PDB, a first PER, and a first utility. The list may include up to N bitrates, N PDBs, N PERs, and N utilities, where N is a positive integer.

As indicated above, FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 120) performs operations associated with RAN assistance information associated with XR split perception.

As shown in FIG. 7, in some aspects, process 700 may include transmitting RAN assistance information associated with an XR split perception (block 710). For example, the UE (e.g., using communication manager 906, depicted in FIG. 9) may transmitting RAN assistance information associated with an XR split perception, as described above in connection with FIGS. 4-6.

As further shown in FIG. 7, in some aspects, process 700 may include receiving, based at least in part on the RAN assistance information, an indication associated with a selected split or offload option for the XR split perception (block 720). For example, the UE (e.g., using communication manager 906, depicted in FIG. 9) may receive, based at least in part on the RAN assistance information, an indication associated with a selected split or offload option for the XR split perception, as described above in connection with FIGS. 4-6.

Process 700 may include additional aspects, such as any single aspect or any combination of aspects described below or in connection with one or more other processes described elsewhere herein.

In a first aspect, the selected split or offload option defines one or more XR perception related tasks to be performed at the UE and one or more XR perception related tasks to be offloaded to a remote server, e.g., as described in connection with FIGS. 4-6.

In a second aspect, alone or in combination with the first aspect, the RAN assistance information indicates a plurality of possible split or offload options for the XR split perception, wherein each possible split or offload option is associated with one or more of a description, an uplink data rate requirement, a PDB requirement, a PER requirement, or a utility, e.g., as described in connection with FIGS. 4-6.

In a third aspect, alone or in combination with one or more of the first and second aspects, the utility is a saved compute power, e.g., as described in connection with FIGS. 4-6.

In a fourth aspect, alone or in combination with one or more of the first through third aspects, the utility is associated with a QoE, e.g., as described in connection with FIGS. 4-6.

In a fifth aspect, alone or in combination with one or more of the first through fourth aspects, the RAN assistance information indicates modem related information associated with the UE, wherein the modem related information includes a UE modem power consumption profile, e.g., as described in connection with FIGS. 4-6.

In a sixth aspect, alone or in combination with one or more of the first through fifth aspects, process 700 includes transmitting the RAN assistance information via an enhanced RBR MAC-CE, wherein the enhanced RBR MAC-CE indicates one or more of a LCID, a QoS flow, a type of utility, a time window during which a provided bitrate query is valid, a number of candidate split or offload options, or a list of supportable bit rates and corresponding utility information, e.g., as described in connection with FIGS. 4-6.

In a seventh aspect, alone or in combination with one or more of the first through sixth aspects, process 700 includes transmitting the RAN assistance information via a RAN visible QoE, and the RAN visible QoE is an application measurement report shared by an application client on the UE with a RAN, e.g., as described in connection with FIGS. 4-6.

In an eighth aspect, alone or in combination with one or more of the first through seventh aspects, process 700 includes transmitting the RAN assistance information via a UAI RRC message, and the UAI RRC message indicates other assistance information including modem information associated with the UE, e.g., as described in connection with FIGS. 4-6.

In a ninth aspect, alone or in combination with one or more of the first through eighth aspects, process 700 includes transmitting the RAN assistance information based at least in part on a periodic update or an event trigger, e.g., as described in connection with FIGS. 4-6.

In a tenth aspect, alone or in combination with one or more of the first through ninth aspects, process 700 includes transmitting the RAN assistance information via an application server, wherein one or more alternative QoS profiles are used as a container to share the RAN assistance information with a RAN, wherein each alternative QoS profile represents one split or offload option, and the indication associated with the selected split or offload option is based at least in part on a selected alternative QoS profile from the one or more alternative QoS profiles, e.g., as described in connection with FIGS. 4-6.

In an eleventh aspect, alone or in combination with one or more of the first through tenth aspects, the selected split or offload option is based at least in part on a current channel condition of the UE and a current network load, and the selected split or offload option is to maximize a number of UEs having a utility that satisfies a threshold or to maximize a minimum utility across a plurality of UEs, e.g., as described in connection with FIGS. 4-6.

In a twelfth aspect, alone or in combination with one or more of the first through eleventh aspects, the selected split or offload option is based at least in part on a UE subscription policy, e.g., as described in connection with FIGS. 4-6.

In a thirteenth aspect, alone or in combination with one or more of the first through twelfth aspects, the selected split or offload option is per UE, e.g., as described in connection with FIGS. 4-6.

In a fourteenth aspect, alone or in combination with one or more of the first through thirteenth aspects, process 700 includes receiving the indication associated with the selected split or offload option via an RBR MAC-CE, wherein the RBR MAC-CE indicates a selected or recommended bitrate, and the selected split or offload option is inferable based at least in part on the selected split or offload option, e.g., as described in connection with FIGS. 4-6.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with RAN assistance information associated with XR split perception.

As shown in FIG. 8, in some aspects, process 800 may include receiving RAN assistance information associated with an XR split perception (block 810). For example, the network node (e.g., using reception component 1002 or communication manager 1006, depicted in FIG. 10) may receive RAN assistance information associated with an XR split perception, as described above in connection with FIGS. 4-6.

As further shown in FIG. 8, in some aspects, process 800 may include transmitting, based at least in part on the RAN assistance information, an indication associated with a selected split or offload option for the XR split perception (block 820). For example, the network node (e.g., using transmission component 1004 or communication manager 1006, depicted in FIG. 10) may transmit, based at least in part on the RAN assistance information, an indication associated with a selected split or offload option for the XR split perception, as described above in connection with FIGS. 4-6.

Process 800 may include additional aspects, such as any single aspect or any combination of aspects described below or in connection with one or more other processes described elsewhere herein.

In a first aspect, the selected split or offload option defines one or more XR perception related tasks to be performed at the UE and one or more XR perception related tasks to be offloaded to a remote server, e.g., as described in connection with FIGS. 4-6.

In a second aspect, alone or in combination with the first aspect, the RAN assistance information indicates a plurality of possible split or offload options for the XR split perception, wherein each possible split or offload option is associated with one or more of a description, an uplink data rate requirement, a PDB requirement, a PER requirement, or a utility, e.g., as described in connection with FIGS. 4-6.

In a third aspect, alone or in combination with one or more of the first and second aspects, the utility is a saved compute power, e.g., as described in connection with FIGS. 4-6.

In a fourth aspect, alone or in combination with one or more of the first through third aspects, the utility is associated with a QoE, e.g., as described in connection with FIGS. 4-6.

In a fifth aspect, alone or in combination with one or more of the first through fourth aspects, the RAN assistance information indicates modem related information associated with a UE, wherein the modem related information includes a UE modem power consumption profile, e.g., as described in connection with FIGS. 4-6.

In a sixth aspect, alone or in combination with one or more of the first through fifth aspects, process 800 includes receiving the RAN assistance information via an enhanced RBR MAC-CE, wherein the enhanced RBR MAC-CE indicates one or more of a LCID, a QoS flow, a type of utility, a time window during which a provided bitrate query is valid, a number of candidate split or offload options, or a list of supportable bit rates and corresponding utility information, e.g., as described in connection with FIGS. 4-6.

In a seventh aspect, alone or in combination with one or more of the first through sixth aspects, process 800 includes receiving the RAN assistance information via a RAN visible QoE, and the RAN visible QoE is an application measurement report shared by an application client on a UE with a RAN, e.g., as described in connection with FIGS. 4-6.

In an eighth aspect, alone or in combination with one or more of the first through seventh aspects, process 800 includes receiving the RAN assistance information via a UAI RRC message, and the UAI RRC message indicates other assistance information including modem information associated with a UE, e.g., as described in connection with FIGS. 4-6.

In a ninth aspect, alone or in combination with one or more of the first through eighth aspects, process 800 includes receiving the RAN assistance information based at least in part on a periodic update or an event trigger, e.g., as described in connection with FIGS. 4-6.

In a tenth aspect, alone or in combination with one or more of the first through ninth aspects, process 800 includes receiving the RAN assistance information via an application server, wherein one or more alternative QoS profiles are used as a container to share the RAN assistance information with a RAN, wherein each alternative QoS profile represents one split or offload option, and the indication associated with the selected split or offload option is based at least in part on a selected alternative QoS profile from the one or more alternative QoS profiles, e.g., as described in connection with FIGS. 4-6.

In an eleventh aspect, alone or in combination with one or more of the first through tenth aspects, the selected split or offload option is based at least in part on a current channel condition of a UE and a current network load, and the selected split or offload option is to maximize a number of UEs having a utility that satisfies a threshold or to maximize a minimum utility across a plurality of UEs, e.g., as described in connection with FIGS. 4-6.

In a twelfth aspect, alone or in combination with one or more of the first through eleventh aspects, the selected split or offload option is based at least in part on a UE subscription policy, e.g., as described in connection with FIGS. 4-6.

In a thirteenth aspect, alone or in combination with one or more of the first through twelfth aspects, the selected split or offload option is per UE, e.g., as described in connection with FIGS. 4-6.

In a fourteenth aspect, alone or in combination with one or more of the first through thirteenth aspects, process 800 includes transmitting the indication associated with the selected split or offload option via an RBR MAC-CE, wherein the RBR MAC-CE indicates a selected or recommended bitrate, and the selected split or offload option is inferable based at least in part on the selected split or offload option, e.g., as described in connection with FIGS. 4-6.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The communication manager 906 may transmitting RAN assistance information associated with an XR split perception. The communication manager 906 may receiving, based at least in part on the RAN assistance information, an indication associated with a selected split or offload option for the XR split perception.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive RAN assistance information associated with an XR split perception. The transmission component 1004 may transmit, based at least in part on the RAN assistance information, an indication associated with a selected split or offload option for the XR split perception.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: transmitting radio access network (RAN) assistance information associated with an extended reality (XR) split perception; and receiving, based at least in part on the RAN assistance information, an indication associated with a selected split or offload option for the XR split perception.
Aspect 2: The method of Aspect 1, wherein the selected split or offload option defines one or more XR perception related tasks to be performed at the UE and one or more XR perception related tasks to be offloaded to a remote server.
Aspect 3: The method of any of Aspects 1-2, wherein the RAN assistance information indicates a plurality of possible split or offload options for the XR split perception, wherein each possible split or offload option is associated with one or more of: a description, an uplink data rate requirement, a packet delay budget requirement, a packet error rate requirement, or a utility.
Aspect 4: The method of Aspect 3, wherein the utility is a saved compute power.
Aspect 5: The method of Aspect 3, wherein the utility is associated with a quality of experience.
Aspect 6: The method of Aspect 3, wherein the RAN assistance information indicates modem related information associated with the UE, wherein the modem related information includes a UE modem power consumption profile.
Aspect 7: The method of any of Aspects 1-6, wherein transmitting the RAN assistance information is via an enhanced requested bitrate (RBR) medium access control control element (MAC-CE), wherein the enhanced RBR MAC-CE indicates one or more of: a logical channel identifier, a quality of service flow, a type of utility, a time window during which a provided bitrate query is valid, a number of candidate split or offload options, or a list of supportable bit rates and corresponding utility information.
Aspect 8: The method of any of Aspects 1-7, wherein transmitting the RAN assistance information is via a RAN visible quality of experience (QoE), and wherein the RAN visible QoE is an application measurement report shared by an application client on the UE with a RAN.
Aspect 9: The method of any of Aspects 1-8, wherein transmitting the RAN assistance information is via a UE assistance information (UAI) radio resource control (RRC) message, and wherein the UAI RRC message indicates other assistance information including modem information associated with the UE.
Aspect 10: The method of any of Aspects 1-9, wherein transmitting the RAN assistance information is based at least in part on a periodic update or an event trigger.
Aspect 11: The method of any of Aspects 1-10, wherein transmitting the RAN assistance information is via an application server, wherein one or more alternative quality of service (QoS) profiles are used as a container to share the RAN assistance information with a RAN, wherein each alternative QoS profile represents one split or offload option, and wherein the indication associated with the selected split or offload option is based at least in part on a selected alternative QoS profile from the one or more alternative QoS profiles.
Aspect 12: The method of any of Aspects 1-11, wherein the selected split or offload option is based at least in part on a current channel condition of the UE and a current network load, and wherein the selected split or offload option is to maximize a number of UEs having a utility that satisfies a threshold or to maximize a minimum utility across a plurality of UEs.
Aspect 13: The method of any of Aspects 1-12, wherein the selected split or offload option is based at least in part on a UE subscription policy.
Aspect 14: The method of any of Aspects 1-13, wherein the selected split or offload option is per UE.
Aspect 15: The method of any of Aspects 1-14, wherein receiving the indication associated with the selected split or offload option is via a recommended bitrate (RBR) medium access control control element (MAC-CE), wherein the RBR MAC-CE indicates a selected or recommended bitrate, and wherein the selected split or offload option is inferable based at least in part on the selected split or offload option.
Aspect 16: A method of wireless communication performed by a network node, comprising: receiving radio access network (RAN) assistance information associated with an extended reality (XR) split perception; and transmitting, based at least in part on the RAN assistance information, an indication associated with a selected split or offload option for the XR split perception.
Aspect 17: The method of Aspect 16, wherein the selected split or offload option defines one or more XR perception related tasks to be performed at a user equipment and one or more XR perception related tasks to be offloaded to a remote server.
Aspect 18: The method of any of Aspects 16-17, wherein the RAN assistance information indicates a plurality of possible split or offload options for the XR split perception, wherein each possible split or offload option is associated with one or more of: a description, an uplink data rate requirement, a packet delay budget requirement, a packet error rate requirement, or a utility.
Aspect 19: The method of Aspect 18, wherein the utility is a saved compute power.
Aspect 20: The method of Aspect 18, wherein the utility is associated with a quality of experience.
Aspect 21: The method of Aspect 18, wherein the RAN assistance information indicates modem related information associated with a user equipment (UE), wherein the modem related information includes a UE modem power consumption profile.
Aspect 22: The method of any of Aspects 16-21, wherein receiving the RAN assistance information is via an enhanced requested bitrate (RBR) medium access control control element (MAC-CE), wherein the enhanced RBR MAC-CE indicates one or more of: a logical channel identifier, a quality of service flow, a type of utility, a time window during which a provided bitrate query is valid, a number of candidate split or offload options, or a list of supportable bit rates and corresponding utility information.
Aspect 23: The method of any of Aspects 16-22, wherein receiving the RAN assistance information is via a RAN visible quality of experience (QoE), and wherein the RAN visible QoE is an application measurement report shared by an application client on a user equipment with a RAN.
Aspect 24: The method of any of Aspects 16-23, wherein receiving the RAN assistance information is via a user equipment (UE) assistance information (UAI) radio resource control (RRC) message, and wherein the UAI RRC message indicates other assistance information including modem information associated with a UE.
Aspect 25: The method of any of Aspects 16-24, wherein receiving the RAN assistance information is based at least in part on a periodic update or an event trigger.
Aspect 26: The method of any of Aspects 16-25, wherein receiving the RAN assistance information is via an application server, wherein one or more alternative quality of service (QoS) profiles are used as a container to share the RAN assistance information with a RAN, wherein each alternative QoS profile represents one split or offload option, and wherein the indication associated with the selected split or offload option is based at least in part on a selected alternative QoS profile from the one or more alternative QoS profiles.
Aspect 27: The method of any of Aspects 16-26, wherein the selected split or offload option is based at least in part on a current channel condition of a user equipment (UE) and a current network load, and wherein the selected split or offload option is to maximize a number of UEs having a utility that satisfies a threshold or to maximize a minimum utility across a plurality of UEs.
Aspect 28: The method of any of Aspects 16-27, wherein the selected split or offload option is based at least in part on a user equipment subscription policy.
Aspect 29: The method of any of Aspects 16-28, wherein the selected split or offload option is per user equipment.
Aspect 30: The method of any of Aspects 16-29, wherein transmitting the indication associated with the selected split or offload option is via a recommended bitrate (RBR) medium access control control element (MAC-CE), wherein the RBR MAC-CE indicates a selected or recommended bitrate, and wherein the selected split or offload option is inferable based at least in part on the selected split or offload option.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories; and
one or more processors coupled to the one or more memories, the one or more processors individually or collectively configured to:
transmit radio access network (RAN) assistance information associated with an extended reality (XR) split perception; and
receive, based at least in part on the RAN assistance information, an indication associated with a selected split or offload option for the XR split perception.

2. The apparatus of claim 1, wherein the selected split or offload option defines one or more XR perception related tasks to be performed at a user equipment and one or more XR perception related tasks to be offloaded to a remote server.

3. The apparatus of claim 1, wherein the RAN assistance information indicates a plurality of possible split or offload options for the XR split perception, and wherein each possible split or offload option is associated with one or more of: a description, an uplink data rate requirement, a packet delay budget requirement, a packet error rate requirement, or a utility.

4. The apparatus of claim 3, wherein the utility is a saved compute power, or wherein the utility is associated with a quality of experience.

5. The apparatus of claim 3, wherein the RAN assistance information indicates modem related information associated with a user equipment (UE), wherein the modem related information includes a UE modem power consumption profile.

6. The apparatus of claim 1, wherein the one or more processors are individually or collectively further configured to:
transmit the RAN assistance information via an enhanced requested bitrate (RBR) medium access control control element (MAC-CE), wherein the enhanced RBR MAC-CE indicates one or more of: a logical channel identifier, a quality of service flow, a type of utility, a time window during which a provided bitrate query is valid, a number of candidate split or offload options, or a list of supportable bit rates and corresponding utility information.

7. The apparatus of claim 1, wherein the one or more processors are individually or collectively further configured to:
transmit the RAN assistance information via a RAN visible quality of experience (QoE), and wherein the RAN visible QoE is an application measurement report shared by an application client on a user equipment with a RAN.

8. The apparatus of claim 1, wherein the one or more processors are individually or collectively further configured to:
transmit the RAN assistance information via a user equipment (UE) assistance information (UAI) radio resource control (RRC) message, and wherein the UAI RRC message indicates other assistance information including modem information associated with a UE.

9. The apparatus of claim 1, wherein the one or more processors are individually or collectively further configured to:
transmit the RAN assistance information based at least in part on a periodic update or an event trigger.

10. The apparatus of claim 1, wherein the one or more processors are individually or collectively further configured to:
transmit the RAN assistance information via an application server, wherein one or more alternative quality of service (QoS) profiles are used as a container to share the RAN assistance information with a RAN, wherein each alternative QoS profile represents one split or offload option, and wherein the indication associated with the selected split or offload option is based at least in part on a selected alternative QoS profile from the one or more alternative QoS profiles.

11. The apparatus of claim 1, wherein the selected split or offload option is based at least in part on a current channel condition of a user equipment (UE) and a current network load, and wherein the selected split or offload option is to maximize a number of UEs having a utility that satisfies a threshold or to maximize a minimum utility across a plurality of UEs.

12. The apparatus of claim 1, wherein the selected split or offload option is based at least in part on a user equipment subscription policy.

13. The apparatus of claim 1, wherein the selected split or offload option is per user equipment.

14. The apparatus of claim 1, wherein the one or more processors are individually or collectively further configured to:
receive the indication associated with the selected split or offload option via a recommended bitrate (RBR) medium access control control element (MAC-CE), wherein the RBR MAC-CE indicates a selected or recommended bitrate, and wherein the selected split or offload option is inferable based at least in part on the selected split or offload option.

15. An apparatus for wireless communication at a network node, comprising:
one or more memories; and
one or more processors coupled to the one or more memories, the one or more processors individually or collectively configured to:
receive radio access network (RAN) assistance information associated with an extended reality (XR) split perception; and
transmit, based at least in part on the RAN assistance information, an indication associated with a selected split or offload option for the XR split perception.

16. The apparatus of claim 15, wherein the RAN assistance information indicates a plurality of possible split or offload options for the XR split perception, wherein each possible split or offload option is associated with one or more of: a description, an uplink data rate requirement, a packet delay budget requirement, a packet error rate requirement, or a utility, and wherein the utility is a saved compute power.

17. The apparatus of claim 15, wherein the one or more processors are individually or collectively further configured to:
receive the RAN assistance information via an enhanced requested bitrate (RBR) medium access control control element (MAC-CE), wherein the enhanced RBR MAC-CE indicates one or more of: a logical channel identifier, a quality of service flow, a type of utility, a time window during which a provided bitrate query is valid, a number of candidate split or offload options, or a list of supportable bit rates and corresponding utility information.

18. The apparatus of claim 15, wherein the one or more processors are individually or collectively further configured to:
receive the RAN assistance information via a RAN visible quality of experience (QoE), and wherein the RAN visible QoE is an application measurement report shared by an application client on a user equipment (UE) with a RAN;
receive the RAN assistance information via a UE assistance information (UAI) radio resource control (RRC) message, and wherein the UAI RRC message indicates other assistance information including modem information associated with the UE; or receive the RAN assistance information based at least in part on a periodic update or an event trigger.

19. The apparatus of claim 15, wherein the one or more processors are individually or collectively further configured to:
receive the RAN assistance information via an application server, wherein one or more alternative quality of service (QoS) profiles are used as a container to share the RAN assistance information with a RAN, wherein each alternative QoS profile represents one split or offload option, and wherein the indication associated with the selected split or offload option is based at least in part on a selected alternative QoS profile from the one or more alternative QoS profiles.

20. A method of wireless communication performed by a user equipment (UE), comprising:
transmitting radio access network (RAN) assistance information associated with an extended reality (XR) split perception; and
receiving, based at least in part on the RAN assistance information, an indication associated with a selected split or offload option for the XR split perception.
